(19) United States
(12) Patent Application Publication
(10) Pub. No.: US 2011/0146417 A1
(43) Pub. Date: Jun. 23, 2011

(54) Portable, hydraulic, direct force, readout apparatus

(76) Inventor: Oliver P. Sheeks, Flippin, AR (US)

(21) Appl. No.: 12/655,235

(22) Filed: Dec. 23, 2009

(51) Int. Cl. G01L 1/02

(52) U.S. Cl. 73/862.584

(57) ABSTRACT

A hydraulic load cell configured to allow direct readout of an applied force in pounds by a standard hydraulic gauge, which is normally calibrated in pounds per square inch. A load is applied generally to the end of the load cell's piston. The piston is fitted with an o'ring in its machined groove and inserted into a fluid filled cylinder; the cylinder having been machined to a tightly controlled diameter of nominally 1.12838 inches. The fluid cavity is joined by a small bore tube to the hydraulic gauge. The three piece device and adjoined gauge is extremely rugged. Pascal's Law of incompressibility of a liquid and the equation of Force=Pressure×Area are utilized to realize the invention's unique simplicity and usefulness. Applications to single and multiple point loading are shown.

### CROSS REFERENCE TO RELATED APPLICATIONS

NA

### STATEMENT REGARDING FEDERALLY SPONSERED RESEARCH OR DEVELOPMENT

NA

### REFERENCE TO SEQUENCE LISTINGS

NA

### BACKGROUND OF THE INVENTION

A. Field of the Invention

The present invention relates to the direct measurement of force applied by a load. The force may be applied in any direction, but the main usefulness illustrated in the invention is to measure vertical loads by vehicles, trailer tongue loads, product weight, and human weight as adapted to each of this situation. Generally, these applications are adapted for singular or point downward loading; the adaptation technique being left up to skill of the user. The invention provides the user with a simple rugged technique of load measurement without the usually attendant complexity of pressure-to-force conversion equipment and digital readout displays.

B. Description of the Background Art

Many businesses are in need of on the spot measurement of product weights and of loading of vehicles and trailers to guarantee safety of movement on roads and to meet highway and vehicle maximum design safe load requirements. The presently available apparatuses are platform scales which are not handy or typically of the bladder type which are cumbersome to fold and unfold and require calibration for their use. These also require pressure readout instruments to convert pressure to electrical signals and to then display the converted signal to an instrument panel for load indication. A trained technician is needed to maintain accuracy of these devices. The present invention overcomes these complexity limitations, allows maximum simplicity, and has precision machined-in load cell calibration accuracy. The accuracy of the gauge is known by its manufacturer's calibration statement at point of purchase.

### OBJECTS OF THE INVENTION

An object of the present invention is to provide a portable, hydraulic, direct force, readout apparatus which includes a generally cylindrical shape containing a loading piston for applying downward force on an enclosed chamber of fluid to create pressure, the chamber having an exit port; the port in turn being connected via a small bore flexible steel tube to a standard off-the-shelf hydraulic gauge thereby transmitting the pressure from the loading piston to the gauge manometer and needle which displays pressure, and in this invention, displays a numerically equal force indication.

Another aspect of this invention is to provide a portable, hydraulic, direct force, readout apparatus with a loading piston with machined o'ring groove and fitted o'ring for the purpose of containing the pressurized fluid in a chamber.

Another object of the invention is to provide said direct force readout apparatus with a precision machined cylinder enclosing the fluid, machining held to a nominal diameter of 1.12838 inches, which value yields a precise one (1) square inch of area upon which the piston and fluid act thereby yielding directly a precise reacting force in pounds on the loaded piston equal to the pressure in pounds per square inch.

Another object of the invention is to provide said direct force readout apparatus with a small bore flexible steel tube which joins said fluid chamber's exit port directly to the readout device, an off-the-shelf hydraulic gauge through typically a standard ¼ NPT fitting; the tube nominally having an outside diameter of 1/16 inch and an inside diameter of 0.040 inch.

Another object of this invention is to provide extension of the application of the portable, direct force, readout apparatus to include measurement of large area loads not easily mounted on single point pistons and to utilize multiple and generally cylindrical shaped cylinders mounted in parallel, each having the similar loading piston and enclosed chamber of fluid per this invention, creating pressures from several points of load contact; here the multiple machined diameters are made to provide exactly an area of pressure so that the sum of the areas of the multiple, hydraulically interconnected, piston/cylinder chambers equal one (1) square inch as previously mentioned, thereby establishing that the sum of forces is equal to the centered load and numerically equal to the common pressure.

Another object of this invention which includes multiple, generally cylindrical shaped, cylinders mounted in parallel, is to provide interconnecting, small bore, flexible steel tubing extending from each cylinder and interconnecting to a common plenum chamber; the plenum chamber outlet then being connected to a single hydraulic gauge for direct force readout in pounds as previously discussed.

Another object of this invention is to provide a feature extension of the application of the portable, hydraulic, direct force, readout apparatus to include the measurement of vehicle or trailer wheel loading by addition an angled loading ramp feature and a flat plate adapter suitably affixed to the top of a single or multiple load cell's piston(s).

It is understood that although the invention disclosed herein is fully capable of achieving the objects and providing the advantages described, the characteristics of the invention described herein are merely illustrative of the preferred embodiments. Accordingly, the inventor does not intend that the scope of the inventor's exclusive rights and privileges in the invention be limited to details of the invention described. It is intended that equivalents, adaptations and modifications of the invention reasonably inferable from the description contained herein be included within the scope of the invention as defined by the appended claims

### SUMMARY OF THE INVENTION

Briefly stated, the present invention contemplates a portable, hydraulic, direct force, readout apparatus. The disclosure reveals that a highly simplified method of determining weight or force may be accomplished by four elements; namely a piston/o'ring/fluid cylinder which piston's force acts upon a contained fluid, a light oil (mineral oil in this proof of concept); the resulting pressure in pounds per square inch is numerically equal to the applied force in pounds because the diameter of the cylinder is controlled by machining to be precisely 1.128379 to within 0.0001 inch tolerance resulting in a pressurized chamber's fluid surface area of 1.0000 square inch. The force is equal to this fixed area times the pressure as measured by an off the shelf hydraulic gauge connected via a small bore steel tubular interface; the gauge's dial is stickered to inform the reader that the reading is also in pounds force units. Ruggedness is realized because all of the cell's metal elements are of stainless steel and the gauge is selected to read to the highest pressure/force anticipated. Any standard gauge may be interchanged as desirable. It is anticipated that loads from zero to tens of thousands of pounds are measurable, even in extreme environments. Adaptations to point loads or area loads may be anticipated and are encouraged by users to fit specific layouts needs. Several adaptations as parts of this invention are shown here for illustration.

### BRIEF DESCRIPTION OF THE DRAWINGS

FIG. 1 is a perspective view of a portable, hydraulic, direct force, readout apparatus according to the present invention showing a piston, cylinder, o'ring, fluid, hydraulic gauge, and interconnecting tubing. An adapter interface fitting and screw thread is shown on top of the piston to which a load of force F is applied. Within the cylindrical volume of area 1.0000 is shown the captive, pressurized fluid. A tubular interface small bore tube is shown interconnecting the cylinder with the hydraulireadout gauge, which is provided with affixed “pounds” label.

FIG. 2 shows the theory basic to the invention; basically stating a) the equation of Force, F, equals Pressure, P, times Area, A, and b) Pascal's Law stating the incompressibility of a liquid.

FIG. 3 shows the perspective schematic of the extension of the invention to include measurement of large area loads using spaced out multiple piston/cylinder devices mounted in parallel; each interconnected via small bore tubing, through a plenum to a single hydraulic gauge.

FIG. 4 shows the perspective of a ramp adaptation to allow measurement of rolling loads.

### DETAILED DESCRIPTION OF THE INVENTION

Referring to FIG. 1, a basic embodiment of the portable, hydraulic, direct force, readout apparatus 21 according to the present invention may be seen to include a piston 1 which under load F applies downward pressure to the fluid 2 contained by cylinder 3 and o'ring 4. The piston 1 is shown to have a diameter of 1.1283792±0.0001 inch which provides an area A of precisely 1 square inch.

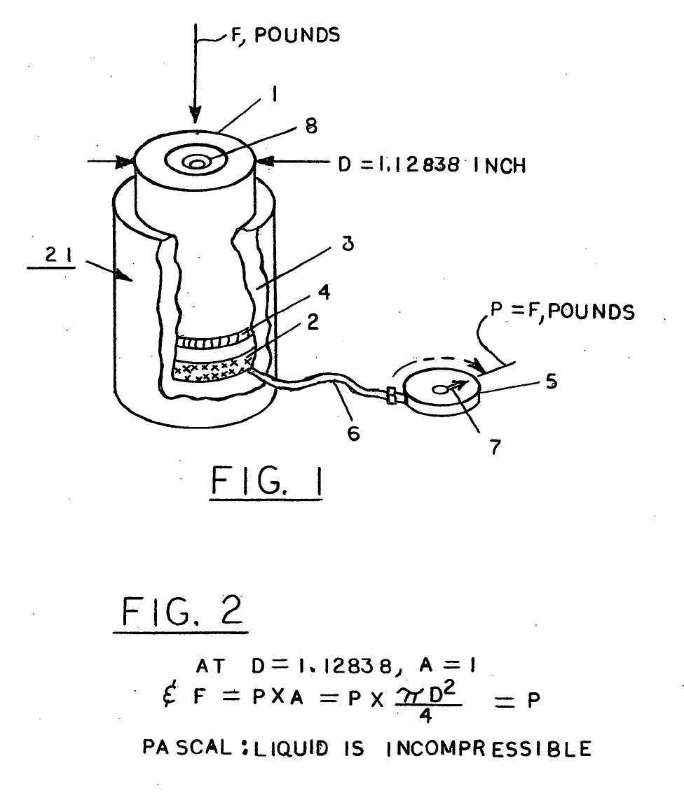

FIG. 2 shows the mathematical relationship between pressure P, force F, and area A. Since Force F equals pressure P times area A, and area A equals π times diameter D squared divided by 4, and area is fixed at the value of one (1) because D is fixed at the value of 1.1283792 , then F is numerically=P, the key to this invention.

The assembly of the functioning elements is shown in FIG. 1. The fluid chamber 3 is connected to the gauge 5 via a small bore steel tube 6. The fluid, being incompressible, transmits the pressure numerically as “Force” directly to the gauge's needle mechanism 7, requiring only enough fluid transfer to accomplish this needle movement; this further simplifies the design since only a very small cylindrical volume is required in the device, thereby making the device small and portable. Additionally, the tube is highly flexible and may be of significant length without effect upon the gauge's performance. This allows for remote reading of the force. The load may be suitably mounted on the piston's upper end via an indention 8 with optional bolt pattern as shown also at 8.

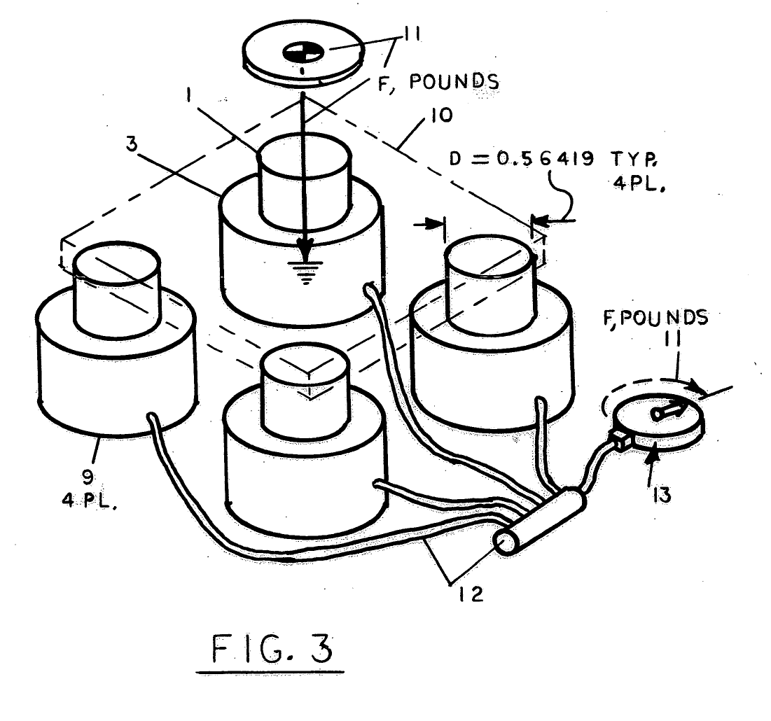

FIG. 3 shows a typical arrangement of multiple piston/cylinder devices 9 under a large area adapter 10 under a Force 11; the pressurized and equal areas of all devices are shown hydraulically interconnected by tubing 12 and thereby sum together equaling one (1) square inch; the gauge 13 recognizes one square inch of pressurized fluid and therefore displays an indication of Force 11 equal to the common pressure.

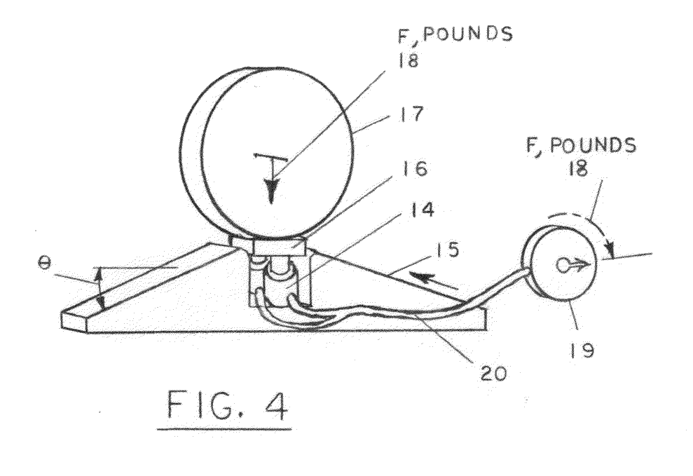

FIG. 4 shows a typical portable, hydraulic, direct force, readout apparatus using either single or multiple load cells 14 in conjunction with a loading ramp 15 and flat plate adapter 16 for loading by a wheel 17 rolling upon the ramp to position the load force 18 on the center of the device. A ramp angle, φ, of 10 to 30 degrees is typical. The gauge 19 is at the end of the flexible tube 20 for remote readout of load.

What is claimed is:

1. A portable, hydraulic, direct force, readout apparatus, having in combination a piston with load adaptability on the upper end, a fluid cylinder, sealing o'ring, exit tube connecting to a hydraulic pressure/force gauge for the purpose of direct force equivalent readout in pounds.

2. The direct force readout apparatus of claim 1 wherein the said piston with load adaptability on the upper end has a point load cup or a bolt pattern to adapt to the downward end of an applied

3. The direct force readout apparatus of claim 1 wherein the said piston is fitted with an o'ring groove and o'ring for the purpose of sealing fluid within the fluid cavity.

4. The direct force readout apparatus of claim 1 wherein the said fluid chamber contains an incompressible fluid upon which the piston acts.

5. The direct force readout apparatus of claim 1 wherein the said exit tube is a small bore stainless tube of significant flexibility and capable of being of significant length to remote locate the gauge from the loaded device.

6. The direct force readout apparatus of claim 1 wherein the hydraulic pressure/force gauge may be an off the shelf hydraulic gauge of standard ¼ NPT adapter size or other suitable size depending on the application.

7. The said point load cup or a bolt pattern of claim 2 may allow for universal adaptation to any load applied.

8. The said fluid of claim 3 may be light oil, as mineral oil, or other liquid compatible with the apparatuses elements.

9. A method of measuring large area loads utilizing multiple piston/cylinder devices; wherein the sum of all pressurized areas as summed together hydraulically by interconnecting tubing provides pressure to a single gauge as if from one square inch of cylinder area; therefore yielding a gauge force readout in pounds numerically to the common pressure in pounds per square inch.

10. A method of measuring large area loads as in claim 9 wherein for the utilization of four (4) devices in parallel the precise cylinder diameters are machined to 0.564171±.0001 inch; also wherein for the utilization of three (3) devices in parallel the precise cylinder diameters are machined to 0.42441±0.0001 inch. Other multiples are similarly derived to provide total piston/cylinder areas summing to one unit of area.

11. A method of measuring wheel loading acting downward on either single or multiple piston/cylinder load cell devices, wherein a loading ramp provides capability to roll the wheel to centrally position the load on the upper end of piston(s) via a flat plate suitably attached to the piston(s).
